(19) United States
(12) Patent Application Publication
(10) Pub. No.: US 2025/0265510 A1
(43) Pub. Date: Aug. 21, 2025

(54) SYSTEMS AND METHODS FOR A GENERATIVE ARTIFICIAL INTELLIGENCE MODEL WITH EVENT PLAN GENERATION

(71) Applicant: Wells Fargo Bank, N.A., San Francisco, CA (US)

(72) Inventors: Shobha Duggirala, San Francisco, CA (US); Cleane Sakaguti, San Francisco, CA (US); Jazz Samra, San Francisco, CA (US)

(73) Assignee: Wells Fargo Bank, N.A., San Francisco, CA (US)

(21) Appl. No.: 18/442,886

(22) Filed: Feb. 15, 2024

(51) Int. Cl. G06Q 10/0631; G06F 40/40

(52) U.S. Cl. CPC G06Q 10/0631; G06Q 10/02; G06Q 10/06311

(57) ABSTRACT

A provider computing system includes at least one processing circuit having at least one processor coupled to at least one memory device. The at least one memory device can store instructions that, when executed by the at least one processor, cause the at least one processing circuit to: receive a query associated with an event; identify one or more parameters absent from at least one first parameter based on an event type of the event; transmit one or more first signals to cause a user device to display a prompt to provide at least one additional parameter regarding the event; receive a first response to the prompt; generate at least one second parameter absent from the first response; determine a plurality of actions to perform the event; and, output a second response identifying the plurality of actions to perform the event, and display a user interface including the second response.

### TECHNICAL FIELD

The present disclosure relates generally to generative artificial intelligence (AI), more specifically to event plan generation of a generative AI model.

### BACKGROUND

AI models may be used to provide information to a user. More specifically, AI models may provide content that pertains to a user based on user information.

### SUMMARY

One embodiment relates to a provider computing system including at least one processing circuit having at least one processor coupled to at least one memory device. The at least one memory device can store instructions that, when executed by the at least one processor, cause the at least one processing circuit to receive, from a user device, a query associated with an event. The query can include at least one first parameter regarding the event. The instructions can also cause the at least one processing circuit to identify, using a machine learning model, one or more parameters absent from the at least one first parameter based on an event type of the event. The instructions can also cause the at least one processing circuit to transmit one or more first signals to cause the user device to display a prompt to provide at least one additional parameter regarding the event. The instructions can also cause the at least one processing circuit to receive, from the user device, a first response to the prompt. The instructions can also cause the at least one processing circuit to generate, using the machine learning model, at least one second parameter absent from the first response. The instructions can also cause the at least one processing circuit to determine, using the machine learning model, a plurality of actions to perform the event. The instructions can also cause the at least one processing circuit to output a second response identifying the plurality of actions to perform the event. The instructions can also cause the at least one processing circuit to transmit one or more second signals to cause the user device to display a user interface including the second response.

Another embodiment relates to a method. The method can include receiving, by a computing system and from a user device, a query associated with an event. The query can include at least one first parameter regarding the event. The method can also include identifying, by the computing system and using a machine learning model, one or more parameters absent from the at least one first parameter based on an event type of the event. The method can also include transmitting, by the computing system, one or more first signals to cause the user device to display a prompt to provide at least one additional parameter regarding the event. The method can also include receiving, by the computing system and from the user device, a first response to the prompt. The method can also include generating, by the computing system using the machine learning model, at least one second parameter absent from the first response. The method can also include determining, by the computing system using the machine learning model, a plurality of actions to perform the event. The method can also include outputting, by the computing system, a second response identifying the plurality of actions to perform the event. The method can also include transmitting, by the computing system, one or more second signals to cause the user device to display a user interface including the second response.

Still another embodiment relates to a non-transitory computer-readable storage media having instructions stored thereon that, when executed by at least one processor of a provider computing system, cause the provider computing system to perform operations including: receiving, from a user device, a query associated with an event, the query comprising at least one first parameter regarding the event; identifying, using a machine learning model, one or more parameters absent from the at least one first parameter based on an event type of the event; transmitting one or more first signals to cause the user device to display a prompt to provide at least one additional parameter regarding the event; receiving, from the user device, a first response to the prompt; generating, using the machine learning model, at least one second parameter absent from the first response; determining, using the machine learning model, a plurality of actions to perform the event; outputting a second response identifying the plurality of actions to perform the event; and, transmitting one or more second signals to cause the user device to display a user interface including the second response.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts a block diagram of a system to provide event plan generation, according to an example embodiment.

FIG. 2 depicts a provider computing system included in the system illustrated in FIG. 1, according to an example embodiment.

FIG. 3 depicts an example user interface that may provide content associated with a user, according to an example embodiment.

FIG. 4 depicts an example user interface that may provide content associated with a user, according to an example embodiment.

FIG. 5 depicts a flow diagram of a method to provide responses corresponding to parameters of one or more events, according to an example embodiment.

FIG. 6 depicts a block diagram of a system, according to an example embodiment.

FIG. 7 depicts a block diagram of a neural network model, according to an example embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein.

The systems, methods, computer-readable media, and apparatuses described herein relate to an artificial intelligence system, and particularly a generative artificial intelligence system, configured or structured to provide event plan generator based on a query from a computing device. According to various embodiments described herein, the systems, methods, and computer-readable media described herein relate to a technical solution of using a generative AI model with event plan generation. The generative AI model may receive queries that identify events, and the generative AI model may generate parameters for the event without subsequent information. The generative AI model may generate the parameters to supplement or provide additional information to improve execution of the event (e.g., fill in gaps or missing information). For example, the generative AI model may receive a query that pertains to a family reunion and the generative AI model may generate parameters that pertain to family reunions.

The systems, methods, and computer-readable media described herein provide and describe various technical improvements to existing AI systems. For example, by generating parameters, without subsequent information, the generative AI model may provide information without a user having to know or ask for the generated parameters. The generation of parameters without a user asking for the parameters may reduce interactions or resources that are allocated to process queries. For example, the generative AI model generating parameters without subsequent queries or responses may reduce interaction between the generative AI model and a computing device of the user. In this way, the generative AI model reduces bandwidth by limiting interactions between the generative AI model and a user. Further, the generative AI model may provide a time savings to a user by providing responses without having a user provide additional information. For example, the generative AI model may receive a simple query and the generative AI model may generate parameters to responds to the simple query without asking the user for subsequent information. Additionally, the generative AI model may be trained to detect correlations between events and one or more previous events. For example, the AI model can be trained to detect that a first event is correlated to one or more second events. To continue this example, the AI model can be trained to extract information corresponding to the second events for use in evaluating the first event. These non-conventional operating characteristics may lead to more desirable AI system operation for users as well as improved resource utilization, by decreasing the number of interactions between the user and the generative AI model by generating parameters without subsequent information from the user. These and other features and benefits are described more fully herein.

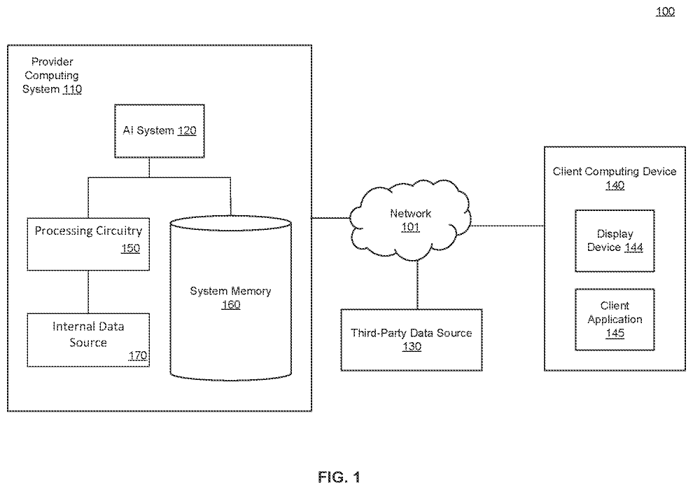

FIG. 1 depicts a block diagram of a system 100 to provide event plan generation utilizing an artificial intelligence (AI) system, according to an example embodiment. As illustrated by way of example in FIG. 1, the system 100 can include at least a network 101, a provider computing system 110 having an AI system 120, a third-party data source 130, and a client computing device 140. The network 101 may communicably couple the components and/or systems to each other. As described herein, the provider computing system 110 may receive inputs (e.g., prompts, responses, information, data, credentials, selections) from a user via a user interface (e.g., a user interface of a display device 144) of the client computing device 140. The provider computing system 110 may query/retrieve/obtain information from one or more data sources (e.g., the third-party data source 130, an internal data source 170) associated with a user (e.g., transaction history, financial information, learning metrics, device interactions), to provide event plan generation for the user. The event plan generation information may pertain to the user. For example, the even plan generation information may pertain to a party that that user is attempting to schedule. The provider computing system 110 may construct and/or generate the event plan information using information that pertains to the user and/or an event that pertains to the user. For example, the provider computing system 110 may generate event plan content that pertains to a user that is creating planning a birthday party. As another example, the event plan content may include content which pertains to a corporate event that the user in planning.

The network 101 can include any type or form of one or more networks. The geographical scope of the network 101 can vary widely and the network 101 can include a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The provider computing system 110 is owned by, associated with, or otherwise operated by a provider institution (e.g., a bank or other financial institution) that maintains one or more accounts held by various customers (e.g., the customer/user associated with the client computing device 140), such as demand deposit accounts, credit card accounts, receivables accounts, and so on. In some instances, the provider computing system 110 may include one or more servers, each with one or more processing circuits having one or more processors configured to execute instructions stored in one or more memory devices to send and receive data stored in the one or more memory devices and perform other operations to implement the features, methods, and operations described herein. In the example shown, the provider computing system 110 includes an AI system 120, a processing circuitry 150, a system memory 160, and an internal data source 170.

The AI system 120 may include one or more servers, databases, or cloud computing environments that may execute one or more generative AI models. The generative AI models may include, but are not limited to, large language models (LLMs), which can be trained to generate human-like text, speech, images, and/or components of graphical user interfaces. The generative AI models may be structured using a deep learning architecture that includes a multitude of interconnected layers, including attention mechanisms, self-attention layers, and transformer blocks. The generative AI models can be trained on large datasets to assimilate patterns, structures, and relationships within the data. The trained generative AI models can be trained to generate outputs that resemble or closely resemble the characteristics of a user and/or an event that pertains to the user. The generative AI models may be fine-tuned to generate specific output data, including data that is compatible with various database architectures or provider computing systems. The generative AI models can be trained via optimization of a large number of parameters, in which the generative AI models learn to minimize the error between its predictions and the actual data points, resulting in highly accurate and coherent generative capabilities. In some embodiments, the AI system 120 may include at least one of a Large Language Model, a generative pre-trained transformer, or a generative artificial intelligence model. For example, the AI system 120 may include and/or be implemented as a generative AI model.

The AI system 120 may include at one or more Machine Learning models or Artificial Intelligence models. For example, the AI system 120 may include regression trees, deep neural networks, supervised learning model, unsupervised learning models, nearest neighbor, generative adversarial networks (GANs), stable diffusers, generative artificial intelligence (GAI), transformers, or many other types of models. The AI system 120 may be trained to detect correlations between events that impact users accounts. For example, the AI system 120 may be trained to detect correlations between declined transaction requests. As another example, the AI system 120 may be trained to detect correlations between opening accounts. The AI system 120 may be tested and/or processed to determine that the AI system 120 is ready to be implemented. For example, the AI system 120 may be found repetitive prompts with similar information. To continue this example, the AI system 120 may be ready for implementation responsive to the AI system 120 providing repetitive responses to similar or identical prompts.

The processing circuitry 150 includes one or more processing circuits including one or more processors coupled to one or more memory devices. The processing circuitry 150 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuitry 150 can include a memory (such as system memory 160, or memory 160) operable to store or storing one or more instructions for operating components of the processing circuitry 150 and operating components operably coupled to the processing circuitry 150. For example, the one or more instructions can include one or more of firmware, software, hardware, operating systems, embedded operating systems. The memory 160 may include one or more devices (e.g., RAM, ROM, Flash memory, hard disk storage) for storing data and/or computer code for completing and/or facilitating the various processes described herein. The memory 160 may include non-transient volatile memory, non-volatile memory, and non-transitory computer storage media, database components, object code components, script components, or any other type of information structure for supporting the various activities and information structures described herein. The processing circuitry 150 or the provider computing system 110 generally can include one or more communication bus controllers to effect communication between the processing circuitry 150 and the other elements of the provider computing system 110.

According to some exemplary embodiments, the provider computing system 110 may comprise an interface controller. The interface controller may be a controller structured or configured to link the provider computing system 110 with one or more of the network 101, the client computing device 140, and the third-party data source 130, by one or more communication interfaces. A communication interface can include, for example, an application programming interface (“API”) compatible with a particular component of the provider computing system 110, the client computing device 140, or the third-party data source 130. The communication interface can provide a particular communication protocol compatible with a particular component of the provider computing system 110 and a particular component of the client computing device 140 or the third-party data source 130. The interface controller can be compatible with particular content objects and can be compatible with particular content delivery systems corresponding to particular content objects, structures of data, types of data, or any combination thereof. For example, the interface controller can be compatible with transmission of video content, audio content, image data, or any combination thereof.

The system memory 160 can store data associated with the provider computing system 110. The system memory 160 can include one or more hardware memory devices to store binary data, digital data, or the like. The system memory 160 can include one or more electrical components, electronic components, programmable electronic components, reprogrammable electronic components, integrated circuits, semiconductor devices, flip flops, arithmetic units, or the like. The system memory 160 can include at least one of a non-volatile memory device, a solid-state memory device, a flash memory device, or a NAND memory device. The system memory 160 can include one or more addressable memory regions disposed on one or more physical memory arrays. A physical memory array can include a NAND gate array disposed on, for example, at least one of a particular semiconductor device, integrated circuit device, and printed circuit board device.

The third-party data source 130 or computing system may be associated with a third-party (e.g., owned by, operated by, managed by, and/or otherwise associated with the third-party). The third-party may be an entity that is a third-party relative to the provider entity/institution. While only one third-party data source is depicted, it should be appreciated that multiple third-parties can be included in the system 100 and coupled, via the network 101, to the provider computing system 110. The third-party data source 130 can be a cloud system, a server, a distributed remote system, or any combination thereof. As another example, the third-party data source 130 can include an operating system configured to execute a virtual environment. The operating system can include hardware control instructions and program execution instructions. The operating system can include a high-level operating system, a server operating system, an embedded operating system, or a boot loader.

The client computing device 140 is owned, operated, controlled, managed, and/or otherwise associated with a user. In this example, the user is a customer of the provider institution. In some embodiments, the client computing device 140 may be or may comprise, for example, a desktop or laptop computer (e.g., a tablet computer), a smartphone, a wearable device (e.g., a smartwatch), a personal digital assistant, and/or any other suitable computing device. In the example shown, the client computing device 140 is structured as a mobile computing device, namely a smartphone. The client computing device 140 can communicate with the provider computing system 110 by the network 101 via one or more communication protocols therebetween.

The client computing device 140 can include one or more I/O devices, a network interface circuit, at least one processing circuit, and various other components and/or systems. The client computing device 140 is shown to include an I/O device as a display device 144. While the term “I/O” is used, it should be understood that the I/O devices may be input-only devices, output-only devices, and/or a combination of input and output devices. In some instances, the I/O devices include various devices that provide perceptible outputs (such as display devices with display screens and/or light sources for visually perceptible elements, an audio speaker for audible elements, and haptics or vibration devices for perceptible signaling via touch, etc.), that capture ambient sights and sounds (such as digital cameras, microphones, etc.), and/or that allow the user to provide inputs (such as a touchscreen display, stylus, keyboard, force sensor for sensing pressure on a display screen. The I/O devices can include a display configured to present a user interface or graphical user interface. The I/O devices can output at least one or more user interface presentations and control affordances. The I/O devices can generate any physical phenomena detectable by human senses, including, but not limited to, one or more visual outputs, audio outputs, haptic outputs, or any combination thereof.

The client computing device 140 can include a display device 144. The display device 144 can display at least one or more user or graphical user interfaces. The display device 144 can include, for example, a liquid crystal display (LCD), a light-emitting diode (LED) display, an organic light-emitting diode (OLED) display, or the like. The display device 144 can receive, for example, capacitive or resistive touch input.

The client computing device 140 is also shown to include a client application 145. The client application 145 may be a financial institution banking application provided by and/or at least partly supported by the provider computing system 110. In some instances, the client application 145 is coupled to the provider computing system 110 and may enable account management regarding one or more accounts held at the provider institution associated with the provider computing system 110 (e.g., funds transfers, bill payment). In some instances, the client application 145 provided by the provider computing system 110 incorporates various functionality provided by or otherwise enabled by the provider computing system 110 (e.g., initiating and/or approving transfers) using one or more application programming interfaces (APIs) and/or software development kits (SDKs) provided by the provider computing system 110. Accordingly, the client application 145 is structured to provide the user with access to various services offered by the provider institution.

The client computing device 140 may execute the client application 145, to provide the user with access to the client application 145 on the client computing device 140. In some embodiments, the client application 145 is hard coded into the memory of the client computing device 140. For example, a user of the client computing device 140 may download the client application 145 and install the client application 145 locally on the client computing device 140. Thus, the client application 145 may be executed or run by one or more processors of the client computing device 140. In some embodiments, the client application 145 is a web-based interface application, where the user logs into or otherwise accesses the web-based interface before usage. In such embodiments, the application may be supported by a separate computing system including one or more servers, processors, network interface circuits, or the like (e.g., the provider computing system 110), that transmit the application data for use to the client computing device 140.

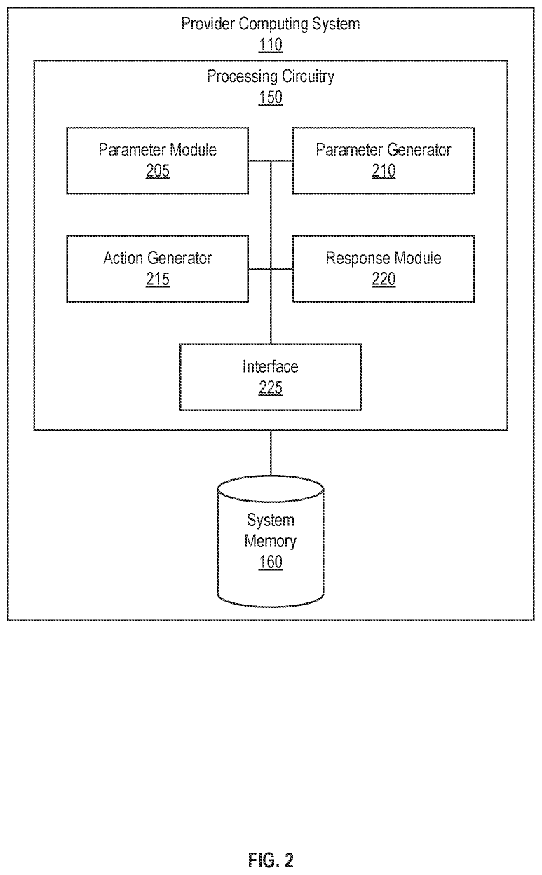

FIG. 2 depicts, in greater detail, the provider computing system 110 of the system 100 of FIG. 1, according to an example embodiment. In some embodiments, the processing circuitry 150 may include at least one parameter module 205, at least one parameter generator 210, at least one action generation 215, at least one response module 220, and at least one interface 225. In some embodiments, the various components and/or devices of the processing circuitry 150 may be stored in the system memory 160. For example, the parameter module 205 may be stored in the system memory 160 as program code, instructions, firmware, and/or executable code. In some embodiments, the system memory 160 may store instructions that cause the processing circuitry 150 to perform the various processes and/or steps described herein. In some embodiments, the system memory 160 may store the various types of information described herein. For example, the system memory 160 may store transaction information that pertains to one or more users.

Referring to FIG. 1 and FIG. 2, in some embodiments, the interface 225 may communicate with, interface with, and/or otherwise interact with the various systems, devices, and/or components of the system 100. For example, the interface 225 may communicate with the client computing device 140. In some embodiments, the interface 225 may include at least one communication device. For example, the interface 225 may include a transceiver. In some embodiments, the interface 225 may include at least one of the interface controller, the communication interface, and/or the various communication devices described herein.

In some embodiments, the interface 225 may transmit one or more signals. For example, the interface 225 may transmit signals to the client computing device 140. In some embodiments, the interface 225 may transmit signals to cause the client computing device 140 to display a user interface. For example, the interface 225 may transmit signals that cause the display device 144 to display a user interface. In some embodiments, the user interfaces may include at least one element (e.g., button, icon, images, graphics) and a user may interact with the elements.

In some embodiments, the interface 225 may receive one or more queries. For example, the interface 225 may receive queries from the client computing device 140. In some embodiments, the interface 225 may receive the queries responsive to a user entering and/or providing information to the client computing device 140. The interface 225 may also receive the queries responsive to a user selecting at least one of elements, buttons, icons, or images included and/or displayed on a user interface. In some embodiments, the queries may include one or more parameters. For example, the queries may identify and/or indicate one or more events. In some embodiments, the queries may include one or more parameters. For example, the query may identify a number of individuals (e.g., parameters) invited to a party (e.g., an event). In some embodiments, the interface 225 may provide the query and/or information corresponding to the query to the parameter module 205.

In some embodiments, the parameter module 205 may identify one or more parameters. For example, the parameter module 205 may identify parameters that pertain to one or more events included in the queries. In some embodiments, the parameter module 205 may implement and/or utilize the AI system 120 to identify the parameters. For example, the parameter module 205 may use the AI system 120 to detect similarities between the events of the queries and one or more previous events. As another example, the AI system 120 may be trained to identify parameters and the parameter module 205 may provide the queries to AI system 120 to identify parameters. In some embodiments, the parameter module 205 may identify parameters that are absent from one or more parameters included in the queries. For example, the parameter module 205 may determine that the query did not identify and/or indicate a date of the event (e.g., a parameter). As another example, the parameter module 205 may determine that the query did not identify a location of the event (e.g., a parameter).

In some embodiments, the parameter module 205 may identify the parameters that were absent from the queries by using the AI system 120. For example, the AI system 120 can be trained to detect and/or identify parameters that correspond to one or more events. To continue this example, the AI system 120 can identify parameters that are absent from the queries responsive to determining that a given event corresponds to a larger number of parameters than the number of parameters included in the queries.

In some embodiments, the parameter module 205 may identify the parameter by retrieving information that corresponds to one or more previous events. For example, the parameter module 205 may retrieve information from the third-party data source 130. In some embodiments, the parameter module 205 may retrieve information that pertains to events having a similar event type. For example, the parameter module 205 may retrieve information that pertains to weddings (e.g., an event type). As another example, the parameter module 205 may retrieve information that pertains to graduation parties (e.g., an event type). In some embodiments, the parameter module 205 may also identify the parameters by comparing the retrieved information with the parameters provided by the user. For example, the parameter module 205 may compare the information and the parameters to identify one or more missing parameters.

In some embodiments, the parameter module 205 may also identify the parameters by determining differences between the parameters provided by the users and the retrieved information. For example, a user may have provided parameters X, Y, and Z and the retrieved information may indicate that, for a given event type, parameters X, Y, Z, A, and B correspond to the given event type. To continue this example, the parameter module 205 may determine that A and B are missing (e.g., one or more differences).

In some embodiments, the interface 225 may transmit one or more signals to cause a device to display a prompt. For example, the interface 225 may transmit signals to the client computing device 140 to cause the display device 144 to display a prompt. In some embodiments, the prompt may request or ask for a user to provide one or more additional parameters. For example, the prompt may ask a user to provide information that corresponds to at least one parameter identified by the parameter module 205. Stated otherwise, the prompt may ask a user to provide a parameter that was absent from the queries.

In some embodiments, the interface 225 may receive one or more responses. For example, the interface 225 may receive a response to the prompt. In some embodiments, the response may include parameters provided by a user. For example, the response may include information that was entered by a user of the client computing device 140. In some embodiments, the interface 225 may provide the response to the parameter generator 210.

In some embodiments, the parameter generator 210 may generate one or more parameters. For example, the parameter generator 210 may generate parameters that were absent from the response. In some embodiments, the parameter generator 210 may generate parameters using the AI system 120. For example, the AI system 120 may be trained to generate parameters based on labeled datasets that were used to train the AI system 120. As another example, the AI system 120 may be trained to generate parameters that correspond to one or more events. To continue this example, the AI system 120 may generate parameters that were absent from one or more interactions with a user. In some embodiments, the parameter generator 210 may provide one or more parameters to the action generator 215. For example, the parameter generator 210 may provide, to the action generator 215, parameters that were provided by a user and/or parameters that were generated by the parameter generator 210.

In some embodiments, the action generator 215 may determine one or more actions. For example, the action generator 215 may determine actions to perform one or more events. In some embodiments, the actions may refer to and/or include one or more aspects for the events. For example, a first action may refer to reserving a venue for an event. As another example, a second action may refer to ordering invitations for the event. As even another example, a third action may refer to selecting a menu for the event. In some embodiments, the action generator 215 may utilize the AI system 120 to generate one or more actions.

In some embodiments, the AI system 120 may be trained, using labeled datasets, to generate the actions. For example, the labeled datasets may include previous actions that were taken to perform one or more previous events. The AI system 120 may be trained to generate actions for subsequent events based on the events or actions included in the labeled datasets. For example, the labeled datasets may include actions that were taken to plan a birthday party (e.g., an event). To continue this example, the AI system 120 may be trained to generate subsequent actions that correspond to birthday parties. As another example, the labeled datasets may include actions that were taken to plan a wedding (e.g., an event). In some embodiments, the action generator 215 may provide the actions to the response module 220.

In some embodiments, the action generator 215 may determine the actions by retrieving publicly accessible information. For example, the action generator 215 may retrieve information from one or more online resources. In some embodiments, the action generator 215 may determine, using the retrieved information, one or more aspects that corresponds to the events and/or event types. For example, the action generator 215 may determine one or more first aspects that pertain to a birthday. As another example, the action generator 215 may determine one or more second aspects that pertain to a holiday gathering. In some embodiments, the action generator 215 may generate the actions based on the one or more aspects.

In some embodiments, the response module 220 may generate one or more responses. For example, the response module 220 may generate responses to the queries. In some embodiments, the response module 220 may generate responses that identify the actions generated by the action generator 215. For example, the response module 220 may generate a response that identifies actions to perform a family reunion. As another example, the response module 220 may generate a response that identifies actions to perform a corporate retreat. In some embodiments, the response module 220 may provide the response to the interface 225. In some embodiments, the interface 225 may transmit one or more signals to cause one or more devices to display a user interface that includes the response. For example, the interface 225 may transmit one or more signals to the client computing device 140 to cause the display device 144 to display a user interface that includes the responses generated by the response module 220.

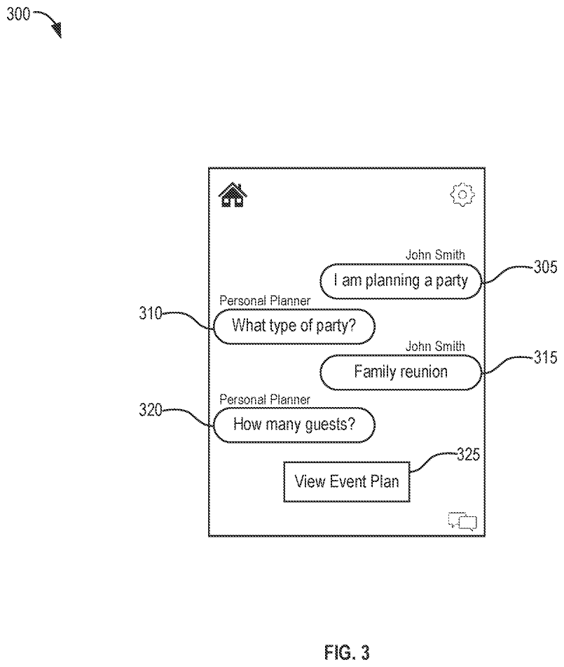

FIG. 3 depicts a user interface 300, according to some embodiments. In some embodiments, the user interface 300 may be displayed via the display device 144. For example, the display device 144 may display the user interface 300 responsive to receiving one or more signals from the interface 225. As another example, the client application 145 may cause the display device 144 to display the user interface. In some embodiments, the user interface 300 may be displayed response to a user selecting one or more icons. In some embodiments, a user may interface with, interact with, or otherwise communicate with the providing computing system 110 via the user interface 300.

The user interface 300 may include one or more exchanges. For example, the user interface 300 may include exchanges between the client computing device 140 and the provider computing system 110. In some embodiments, the exchanges may include at least one of queries, responses, and/or prompts. For example, the user interface 300 is shown to include a query 305. As shown in FIG. 3, the query 305 includes the message “I am planning a party.” In some embodiments, the query 305 may be provided to the provider computing system 110.

In some embodiments, the provider computing system 110 may provide one or more responses and/or prompts. For example, the user interface 300 is shown to include prompt 310. As shown in FIG. 3, the prompt 310 includes the message “what type of party.” In some embodiments, the prompt 310 may be a prompt to provide one or parameters that pertain to one or more events. For example, the query 305 identify the event as a party and the provider computing system 110 provided, responsive to the query 305, a response.

In some embodiments, the user interface 300 can include a response 315. The response 315 may be a response provided by a user. In some embodiments, the provider computing system 110 may receive the response 315 responsive to providing the prompt 310. In some embodiments, the provider computing system 110 may provide one or more subsequent prompts and/or responses. For example, the user interface 300 is shown to include a response 320 with the message “How many guests?” In some embodiments, the user interface 300 may include at least one button 325 or element 325. A user may select the element 325 to view one or actions generated by the provider computing system 110. In some embodiments, the provider computing system 110 may generate, provide, update, modify, adjust, or display one or more subsequent user interface responsive to selection of the element 325.

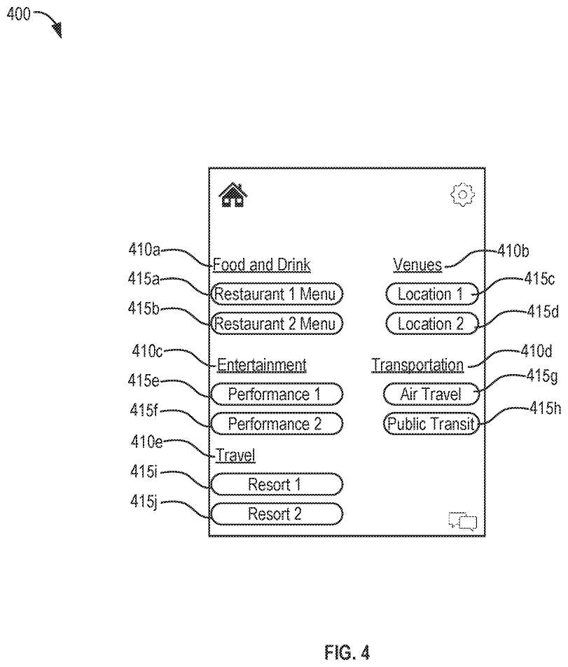

FIG. 4 depicts a user interface 400, according to some embodiments. In some embodiments, the user interface 400 may be displayed via the display device 144. For example, the display device 144 may display the user interface 400 responsive to receiving one or more signals from the interface 225. In some embodiments, the user interface 400 may be generated, provided, presented, and/or otherwise displayed responsive to a selection of the element 325.

In some embodiments, the user interface 400 may include at least one action 410. The action generator 215 may generate or determine the actions 410. In some embodiments, the actions 410 may be organized and/or positioned within the user interface 400 based on action categories or action types. As shown in FIG. 4, the actions 410 are shown to include corresponding options 415. In some embodiments, the options 415 may represent a given action associated with the actions 410. For example, action 410a is shown to correspond to food and drink. To continue this example, the options 415a and 415b are shown to correspond to restaurant 1 menu and restaurant 2 menu.

In some embodiments, the provider computing system 110 may receive one or more indications. For example, the provider computing system 110 may receive indications of one or more selections within the user interface 300 and/or the user interface 400. The selections may be a user selecting at least one action 410 or option 415. In some embodiments, the provider computing system 110 may identify one or more entities. For example, the provider computing system 110 may identify entities to perform one or more of the actions. In some embodiments, the entities may include entities that perform and/or coordinate one or more of the actions. For example, an action may be to order food for an event and a corresponding entity may be a contact person for a restaurant that will be providing food for the event.

In some embodiments, the provider computing system 110 may transmit, via the interface 225, one or more signals to cause one or more devices to display information associated with the entities. For example, the provider computing system 110 may transmit signals to cause at least one of the user interface 300 and/or the user interface 400 to be updated to display information associated with the entities. As another example, the provider computing system 110 may transmit signals to cause the display device 144 to display a user interface that include information associated with the entities.

In some embodiments, the provider computing system 110 may receive one or more indications. For example, the provider computing system 110 may receive an indication of a selection of one or more entities. The provider computing system 110 may receive the indications responsive to a user selecting at least one element displayed on the user interfaces. For example, the provider computing system 110 may receive an indication responsive to a user selecting icon 410c.

In some embodiments, the provider computing system 110 may transmit one or more signals to display one or more prompts. For example, the provider computing system 110 may transmit signals to cause the display device 144 to display a prompt. To continue this example, the prompt may be a prompt to request a reservation. In some embodiments, the reservations may be reservations to reserve one or more of the entities. For example, a request for a first reservation may be to reserve a venue (e.g., an entity).

In some embodiments, the provider computing system 110 may transmit one or more signals to a user device associated with the entities. For example, the provider computing system 110 may transmit signals to one or more client computing devices 140 that pertain to the entities. The provider computing system 110 may transmit the signals to request reservation of the entities. For example, the provider computing system 110 may transmit signals that cause a user device (e.g., the client computing device 140) a first entity to display a prompt requesting to reserve the first entity.

In some embodiments, the provider computing system 110 may receive one or more responses. For example, the provider computing system 110 may receive a response to a prompt. To continue this example, the prompt may be a request to reserve a first entity and the response may be an answer to the request. The response may provide an indication of a reservation with the first entity. The response may also provide an indication that the first entity is booked and/or unavailable. In some embodiments, the provider computing system 110 may update the user interfaces responsive to the responses. For example, a first response may indicate that a first venue has been reserved. To continue this example, a user interface that includes a list of venues may be updated to reflect that the first venue has been reserved. In some embodiments, the user interface may also be updated to remove one or more entities. For example, one or more entities that represent venues may be removed from the user interface responsive to reserving the first entity. As another example, one or more entities may be added to the user interface response to reserving the first entity. To continue this example, the one or more entities may be associated with the first entity.

In some embodiments, the provider computing system 110 may update one or more responses. For example, the provider computing system 110 may update the responses that were provided to the client computing devices 140. As another example, the provider computing system 110 may update the responses that were generated responsive to receiving one or more queries. In some embodiments, the provider computing system 110 may update the responses to include indications of entities that are associated with one another. For example, the provider computing system 110 may receive confirmation that a first entity has been reserved. To continue this example, the provider computing system 110 may update a response to indicate one or more entities associated with the first entity. As another example, a first entity and a second entity may both be event venues. To continue this example, a response that includes indications of the first entity and the second entity may be updated responsive to a determination that one or more venues (e.g., the first entity and/or the second entity) are unavailable. As even another example, a first entity and a second entity may both be catering companies and a user interface that lists both the first entity and the second entity may be updated responsive to a selection of a venue (e.g., a third entity). In some embodiments, the provider computing system 110 may transmit one or more signals to cause a device to display the responses that include the indications of the associated entities.

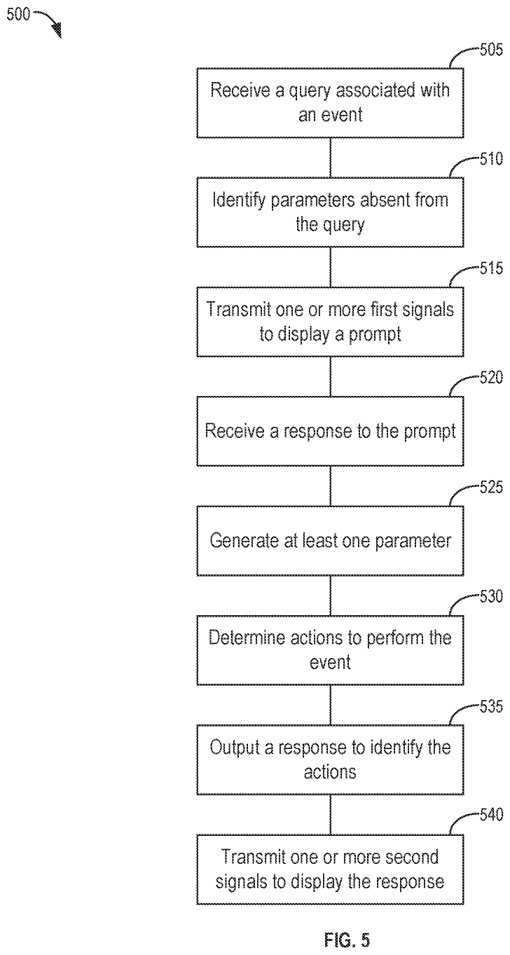

FIG. 5 depicts a flow diagram of a method 500 to provide event plan generation, according to an example embodiment. Various components and/or systems of the provider computing system 110 can perform the method 500. Via the method 500, the provider computing system 110 may receive various queries from devices and the queries may pertain to one or more events. The provider computing system 110 may also provide one or more response to the querying, via the method 500. For example, the provider computing system 110 may transmit one or more signals to cause the client computing device 140 to display one or more user interfaces that include responses generated by the AI system 120.

In step 505, a query associated with an event may be received. For example, the interface 225 may receive a query from the client computing device 140. In some embodiments, the interface 225 may receive the query responsive to a user providing information to the client computing device 140. For example, the user may provide information that identifies an event. As another example, the user may initiate a session, via the client application 145, with the provider computing system 110. To continue this example, initiation of the session may trigger transmission of the query.

In step 510, parameters absent from the query may be identified. For example, the parameter module 205 may identify one or more parameters that were absent from the query received in step 505. In some embodiments, the parameter module 205 may identify one or more parameters for events. For example, the parameter module 205 may identify parameters for an event that was identified in the query received in step 505. In some embodiments, the parameter module 205 may identify the parameters by utilizing the AI system 120. For example, the parameter module 205 may provide inputs to the AI system 120 and the AI system 120 may provide outputs. In some embodiments, the parameter module 205 may identify the parameters by identifying or detecting information that is absent from the query. For example, the query may have identified the event as a birthday party (e.g., an event). To continue this example, the parameter module 205 may identify that the query did not identify a date of the birthday party (e.g., a parameter).

In step 515, one or more first signals may be transmitted to display a prompt. For example, the interface 225 may transmit signals to the client computing device 140 that cause the display device 144 to display a prompt. In some embodiments, the prompt may be a prompt to provide additional or subsequent parameters. For example, the prompt may be a prompt to provide information that pertains to the parameters identified by the parameter module 205 in step 510.

In step 520, a response to the prompt may be received. For example, the interface 225 may receive a response to the prompt that was display in step 515. In some embodiments, the interface 225 may receive the response responsive to a user selecting, interfacing with, or otherwise interacting with elements or icons of a user interface. For example, the interface 225 may receive the response responsive to a user entering information into a text box of a user interface.

In step 525, at least one parameter may be generated. For example, the parameter generator 210 may generate at least one parameter. In some embodiments, the parameter generator 210 may generate parameters that were absent from the response received in step 520. For example, the prompt may have requested, from the user in response to the query, parameter A, parameter B, and parameter C. To continue this example, the response may have included parameter A and parameter B. In this example, the parameter generator 210 may generate parameter C. For example, parameter C may be a date for the event. To continue this example, the parameter generator 210 may access or view a calendar of a user. In this example, the parameter generator 210 may generate one or more dates (e.g., parameters) based on information obtained from the calendar. As another example, the parameter generator may generate one or more dates based on information associated with one or more parameters. In this example, parameter A may be a venue and the date of the event (e.g., parameter C) may be generated based on availability of the venue.

In step 530, actions to perform the event may be determined. For example, the action generator 215 may determine actions to perform the event that was identified in step 505. In some embodiments, the action generator 215 may determine the actions by utilizing the AI system 120. For example, the action generator 215 may provide parameters, as inputs, to the AI system 120, and the AI system 120 may generate actions (e.g., outputs). In some embodiments, the action generator 215 may generate actions that pertain to one or more aspects of the event. For example, the action generator 215 may generate actions to reserve a venue for a party. As another example, the action generator 215 may generate actions to reserve a caterer for a corporate event.

In step 535, a response to identify the actions may be output. For example, the response module 220 may output a response that identifies actions determined in step 530. In some embodiments, the response module 220 may output the responses responsive to generating the responses based on information provided by the action generator 215, the parameter module 205, or the parameter generator 210. For example, the response module 220 may receive information that corresponds to the actions and the response module 220 may generate a response that identifies the actions.

In step 540, one or more second signals may be transmitted to display the response. For example, the interface 225 may transmit signals to cause the display device 144 to display the response output in step 535. In some embodiments, the interface 225 may transmit signals that causes the display device 144 to provide, produce, adjust, update, modify, or otherwise modify one or more user interfaces. For example, the interface 225 may transmit signals that causes the display device 144 to display the user interface 400. As another example, the interface 225 may transmit signals that cause the display device 144 to update the user interface 400.

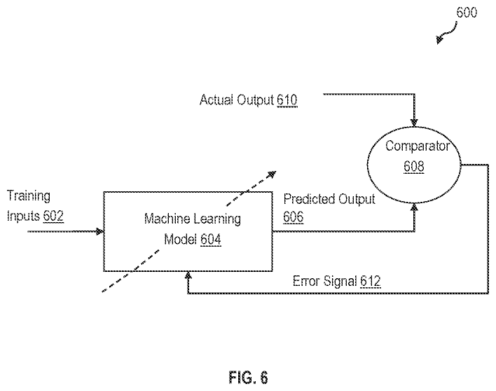

Referring to FIG. 6, a block diagram of an example system 600 using supervised learning, is shown. Supervised learning is a method of training a machine learning model given input-output pairs. An input-output pair is an input with an associated known output (e.g., an expected output).

Machine learning model 604 may be trained on known input-output pairs such that the machine learning model 604 can learn how to predict known outputs given known inputs. Once the machine learning model 604 has learned how to predict known input-output pairs, the machine learning model 604 can operate on unknown inputs to predict an output. For example, the machine learning model 604 may learn to predict responses to one or more queries.

The machine learning model 604 may be trained based on general data and/or granular data (e.g., data based on a specific user 632) such that the machine learning model 604 may be trained specific to a particular user 632.

Training inputs 602 and actual outputs 610 may be provided to the machine learning model 604. Training inputs 602 may include labeled datasets that correspond to events and actions taken to address the events. The training inputs 602 can also include prompts to provide to one or more users. For example, the training inputs 602 may include parameters associated with one or more events. As another example, the training inputs 602 may include responses to one or more queries.

The inputs 602 and actual outputs 610 may be received from the internal data source 170. The inputs 602 and the actual outputs 610 may be received from of the various data repositories described herein. For example, the inputs 602 and the outputs 610 may be received from the third-party data source 130. Thus, the machine learning model 604 may be trained to predict at least one of events, actions, or sessions based on the training inputs 602 and actual outputs 610 used to train the machine learning model 604.

The system 600 may include one or more machine learning models 604. In an embodiment, a first machine learning model 604 may be trained to predict data for one or more events. For example, the first machine learning model 604 may use the training inputs 602 to predict outputs 606, by applying the current state of the first machine learning model 604 to the training inputs 602. The comparator 608 may compare the predicted outputs 606 to actual outputs 610 to determine an amount of error or differences. For example, the predicted event (e.g., predicted output 606) may be compared to the actual event (e.g., actual output 610).

In other embodiments, a second machine learning model 604 may be trained to make one or more recommendations to the user 632 based on the predicted output from the first machine learning model 604. For example, the second machine learning model 604 may use the training inputs 602 to predict outputs 606 by applying the current state of the second machine learning model 604 to the training inputs 602. The comparator 608 may compare the predicted outputs 606 to actual outputs 610 to determine an amount of error or differences.

In some embodiments, a single machine leaning model 604 may be trained to make one or more recommendations to the user 632 based on current user 632 data received from enterprise resources 628. That is, a single machine leaning model may be trained using the training inputs to predict outputs 606 by applying the current state of the machine learning model 604 to the training inputs 602. The comparator 608 may compare the predicted outputs 606 to actual outputs 610 to determine an amount of error or differences. The actual outputs 610 may be determined based on historic data associated with the recommendation to the user 632.

During training, the error (represented by error signal 612) determined by the comparator 608 may be used to adjust the weights in the machine learning model 604 such that the machine learning model 604 changes (or learns) over time. The machine learning model 604 may be trained using a backpropagation algorithm, for instance. The backpropagation algorithm operates by propagating the error signal 612. The error signal 612 may be calculated each iteration (e.g., each pair of training inputs 602 and associated actual outputs 610), batch and/or epoch, and propagated through the algorithmic weights in the machine learning model 604 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 604 may be tuned to reduce the amount of error, thereby minimizing the differences between (or otherwise converging) the predicted output 606 and the actual output 610. The machine learning model 604 may be trained until the error determined at the comparator 608 is within a certain threshold (or a threshold number of batches, epochs, or iterations have been reached). The trained machine learning model 604 and associated weighting coefficients may subsequently be stored in memory 616 or other data repository (e.g., a database) such that the machine learning model 604 may be employed on unknown data (e.g., not training inputs 602). Once trained and validated, the machine learning model 604 may be employed during a testing (or an inference phase). During testing, the machine learning model 604 may ingest unknown data to predict future data (e.g., actions, events, sessions, and the like).

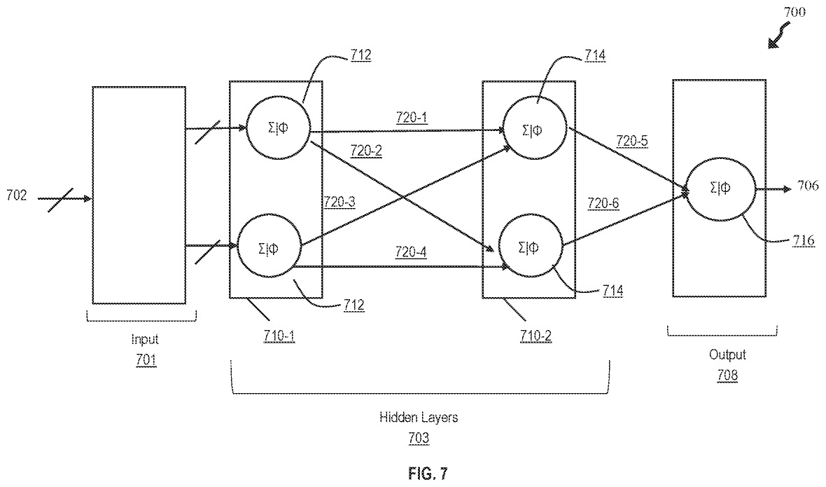

Referring to FIG. 7, a block diagram of a simplified neural network model 700 is shown. The neural network model 700 may include a stack of distinct layers (vertically oriented) that transform a variable number of inputs 702 being ingested by an input layer 704, into an output 706 at the output layer 708.

The neural network model 700 may include a number of hidden layers 710 between the input layer 704 and output layer 708. Each hidden layer has a respective number of nodes (712, 714 and 716). In the neural network model 700, the first hidden layer 710-1 has nodes 712, and the second hidden layer 710-2 has nodes 714. The nodes 712 and 714 perform a particular computation and are interconnected to the nodes of adjacent layers (e.g., nodes 712 in the first hidden layer 710-1 are connected to nodes 714 in a second hidden layer 710-2, and nodes 714 in the second hidden layer 710-2 are connected to nodes 716 in the output layer 708). Each of the nodes (712, 714 and 716) sum up the values from adjacent nodes and apply an activation function, allowing the neural network model 700 to detect nonlinear patterns in the inputs 702. Each of the nodes (712, 714 and 716) are interconnected by weights 720-1, 720-2, 720-3, 720-4, 720-5, 720-6 (collectively referred to as weights 720). Weights 720 are tuned during training to adjust the strength of the node. The adjustment of the strength of the node facilitates the neural network's ability to predict an accurate output 706.

In some embodiments, the output 706 may be one or more numbers. For example, output 706 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a one or more computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions and embodiment of the embodiments without departing from the scope of the present disclosure as expressed in the appended claims.

What is claimed is:

1. A provider computing system comprising:
at least one processing circuit having at least one processor coupled to at least one memory device, the at least one memory device storing instructions thereon that, when executed by the at least one processor, cause the at least one processing circuit to:
receive, from a user device, a query associated with an event, the query comprising at least one first parameter regarding the event;
identify, using a machine learning model, one or more parameters absent from the at least one first parameter based on an event type of the event;
transmit one or more first signals to cause the user device to display a prompt to provide at least one additional parameter regarding the event;
receive, from the user device, a first response to the prompt;
generate, using the machine learning model, at least one second parameter absent from the first response;
determine, using the machine learning model, a plurality of actions to perform the event;
output a second response identifying the plurality of actions to perform the event; and
transmit one or more second signals to cause the user device to display a user interface including the second response.

2. The provider computing system of claim 1, wherein the instructions further cause the at least one processing circuit to:
receive, from the user device, an indication of a selection of one or more actions of the plurality of actions;
identify, based on the one or more actions, one or more entities to perform the one or more actions; and
transmit one or more third signals to cause the user device to display information associated with the one or more entities.

3. The provider computing system of claim 2, wherein the instructions further cause the at least one processing circuit to:
receive, from the user device, an indication of a selection of a first entity of the one or more entities;
transmit one or more fourth signals to cause the user device to display a prompt to request reservation of the first entity of the one or more entities; and
transmit, to a user device associated with the first entity of the one or more entities, a message to request reservation of the first entity.

4. The provider computing system of claim 3, wherein the instructions further cause the at least one processing circuit to:
receive, from the user device associated with the first entity, a third response indicating a reservation with the first entity;
update, responsive to receiving the third response, the second response to remove one or more entities from the second response or to add one or more entities to the second response; and
transmit one or more fifth signals to cause the user device to display the second response to reflect updating the second response.

5. The provider computing system of claim 3, wherein the instructions further cause the at least one processing circuit to:
update the second response to include indications of one or more second entities of the one or more entities associated with the first entity; and
transmit one or more fifth signals to cause the user device to display the second response to reflect updating the second response.

6. The provider computing system of claim 1, wherein identifying the one or more parameters absent from the at least one first parameter based on the event type of the event includes:
retrieving a plurality of information corresponding to previous events having the event type;
comparing, using the machine learning model, the at least one first parameter and the plurality of information;
identifying, using the machine learning model, one or more differences between the at least one first parameter and the plurality of information; and
identifying, using the machine learning model, the one or more parameters absent from the at least one first parameter based the one or more differences.

7. The provider computing system of claim 1, wherein determining the plurality of actions to perform the event includes:
retrieving a plurality of information from a publicly accessible source, the plurality of information indicating previous actions performed for previous events having the event type;
identifying, using the machine learning model, the previous actions responsive to examination of the plurality of information;
determining, using the machine learning model, that given actions of the previous actions pertain to given aspects of the previous events; and
detecting, using the machine learning model, similarities between one or more given aspects of the previous events and one or more aspects of the event, wherein the one or more aspects of the event are indicated by at least one of the at least one first parameter or the at least one second parameter.

8. The provider computing system of claim 1, wherein the machine learning model includes at least one of:
a large language model;
a generative pre-trained transformer; or
a generative artificial intelligence model.

9. A method, comprising:
receiving, by a computing system and from a user device, a query associated with an event, the query comprising at least one first parameter regarding the event;
identifying, by the computing system and using a machine learning model, one or more parameters absent from the at least one first parameter based on an event type of the event;
transmitting, by the computing system, one or more first signals to cause the user device to display a prompt to provide at least one additional parameter regarding the event;
receiving, by the computing system and from the user device, a first response to the prompt;
generating, by the computing system using the machine learning model, at least one second parameter absent from the first response;
determining, by the computing system using the machine learning model, a plurality of actions to perform the event;
outputting, by the computing system, a second response identifying the plurality of actions to perform the event; and
transmitting, by the computing system, one or more second signals to cause the user device to display a user interface including the second response.

10. The method of claim 9, further comprising:
receiving, by the computing system from the user device, an indication of a selection of one or more actions of the plurality of actions;
identifying, by the computing system, based on the one or more actions, one or more entities to perform the one or more actions; and
transmitting, by the computing system, one or more third signals to cause the user device to display information associated with the one or more entities.

11. The method of claim 10, further comprising:
receiving, by the computing system, from the user device, an indication of a selection of a first entity of the one or more entities;
transmitting, by the computing system, one or more fourth signals to cause the user device to display a prompt to request reservation of the first entity of the one or more entities; and
transmitting, by the computing system, to a user device associated with the first entity of the one or more entities a message to request reservation of the first entity.

12. The method of claim 11, further comprising:
receiving, by the computing system from the user device associated with the first entity, a third response indicating a reservation with the first entity;
updating, by the computing system, responsive to receiving the third response, the second response to remove one or more entities from the second response or to add one or more entities to the second response; and
transmitting, by the computing system, one or more fifth signals to cause the user device to display the second response to reflect updating the second response.

13. The method of claim 11, further comprising:
updating, by the computing system, the second response to include indications of one or more second entities of the one or more entities associated with the first entity; and
transmitting, by the computing system, one or more fifth signals to cause the user device to display the second response to reflect updating the second response.

14. The method of claim 9, wherein identifying the one or more parameters absent from the at least one first parameter based on the event type of the event includes:
retrieving, by the computing system, a plurality of information corresponding to previous events having the event type;
comparing, by the computing system using the machine learning model, the at least one first parameter and the plurality of information;
identifying, by the computing system using the machine learning model, one or more differences between the at least one first parameter and the plurality of information; and
identifying, by the computing system using the machine learning model, the one or more parameters absent from the at least one first parameter based the one or more differences.

15. The method of claim 9, wherein determining the plurality of actions to perform the event includes:
retrieving, by the computing system, a plurality of information from a publicly accessible source, the plurality of information indicating previous actions performed for previous events having the event type;
identifying, by the computing system using the machine learning model, the previous actions responsive to examination of the plurality of information;
determining, by the computing system using the machine learning model, that given actions of the previous actions pertain to given aspects of the previous events; and
detecting, by the computing system using the machine learning model, similarities between one or more given aspects of the previous events and one or more aspects of the event, wherein the one or more aspects of the event are indicated by at least one of the at least one first parameter or the at least one second parameter.

16. The method of claim 9, wherein the machine learning model includes at least one of:
a large language model;
a generative pre-trained transformer; or
a generative artificial intelligence model.

17. A non-transitory computer-readable storage media having instructions stored thereon that, when executed by at least one processor of a provider computing system, cause the provider computing system to perform operations comprising:
receiving, from a user device, a query associated with an event, the query comprising at least one first parameter regarding the event;
identifying, using a machine learning model, one or more parameters absent from the at least one first parameter based on an event type of the event;
transmitting one or more first signals to cause the user device to display a prompt to provide at least one additional parameter regarding the event;
receiving, from the user device, a first response to the prompt;
generating, using the machine learning model, at least one second parameter absent from the first response;
determining, using the machine learning model, a plurality of actions to perform the event;
outputting a second response identifying the plurality of actions to perform the event; and
transmitting one or more second signals to cause the user device to display a user interface including the second response.

18. The non-transitory computer-readable storage media of claim 17, wherein the instructions, when executed by the at least one processor of the provider computing system, further cause the provider computing system to perform operations comprising:
receiving, from the user device, an indication of a selection of one or more actions of the plurality of actions;
identifying, based on the one or more actions, one or more entities to perform the one or more actions; and
transmitting one or more third signals to cause the user device to display information associated with the one or more entities.

19. The non-transitory computer-readable storage media of claim 18, wherein the instructions, when executed by the at least one processor of the provider computing system, further cause the provider computing system to perform operations comprising:
receiving, from the user device, an indication of a selection of a first entity of the one or more entities;
transmitting one or more fourth signals to cause the user device to display a prompt to request reservation of the first entity of the one or more entities; and
transmitting, to a user device associated with the first entity of the one or more entities, a message to request reservation of the first entity.

20. The non-transitory computer-readable storage media of claim 19, wherein the instructions, when executed by the at least one processor of the provider computing system, further cause the provider computing system to perform operations comprising:
receiving, from the user device associated with the first entity, a third response indicating a reservation with the first entity;
updating, responsive to receiving the third response, the second response to remove one or more entities from the second response or to add one or more entities to the second response; and
transmitting one or more fifth signals to cause the user device to display the second response to reflect updating the second response.
